(19) United States
(12) Patent Application Publication
(10) Pub. No.: US 2025/0175265 A1
(43) Pub. Date: May 29, 2025

(54) WIRELESS TRANSMITTER DEVICE FOR MM-WAVE/THZ-BASED COMMUNICATION AND GAS-SENSING

(71) Applicant: SIGNIFY HOLDING B.V., EINDHOVEN (NL)

(72) Inventor: PETER DEIXLER, ARLINGTON, MA (US)

(21) Appl. No.: 18/726,863

(22) PCT Filed: Dec. 23, 2022
(86) PCT No.: PCT/EP2022/087690

§ 371 Date: Jul. 5, 2024

Related U.S. Application Data
(60) Provisional application No. 63/296,911, filed on Jan. 6, 2022.

(30) Foreign Application Priority Data
Jan. 14, 2022 (EP) 22151496.1

(51) Int. Cl. H04B 17/318; G01N 22/00; H04B 17/309

(52) U.S. Cl. CPC H04B 17/318; G01N 22/00; H04B 17/347

(57) ABSTRACT

The invention is directed to a wireless transmitter device (100), comprising a signal provision unit (102) for providing wireless mm-wave/THz-communication signals (104), an operation-mode ascertaining unit (108) for ascertaining operation data (110) indicative of a desired operation mode from a plurality of available operation modes including a communication operation mode for data communication and a gas-sensing operation mode for sensing, using the mm-wave/THz-communication signals (104), a presence of a predetermined gas (112) within a gas-sensing volume (114), and a signal-parameter determination unit (116) connected to the operation-mode ascertaining unit and to the signal provision unit and for determining emission parameters of the mm-wave/THz-communication signals to be provided in dependence on the desired operation mode. The signal provision unit is configured to provide mm-wave/THz-communication signals in accordance with the determined emission parameters and thus enables an increase of the functionality of wireless transmitter devices operating in the mm-wave/THz communication band.

### FIELD OF THE INVENTION

The present invention is directed to a wireless transmitter device, to a wireless communication arrangement, to respective methods for controlling operation of a wireless transmitter device and a wireless operation arrangement and to a computer program product.

### BACKGROUND OF THE INVENTION

The THz frequency band, also referred to as THF (tremendously high frequency) is based on the use of terahertz radiation, also referred to as submillimeter radiation, terahertz waves, T-rays, T-waves, which consists of electromagnetic waves within the International Telecommunication Union (ITU)-designated band of frequencies from 0.3 to 3 THz, although the upper boundary is considered by other sources to be 30 THz. Wavelengths of radiation in the THz band correspondingly range from 1 mm to 0.01 mm. Terahertz radiation is strongly absorbed by gases in the atmosphere, and in air is attenuated to zero within a few meters.

The mm-wave band, also referred to as EHF (extremely high frequency) is the designation by the ITU for the band of radiofrequencies (RF) in the electromagnetic spectrum from 30 to 300 GHz. Compared to lower bands, radio waves in the mm-wave band also have high atmospheric attenuation and have therefore a short range. For example, the Wi-Fi standards IEEE 802.11.ad and IEEE 802.11.ay operate in the 60 GHz, V band, spectrum and achieve data transfer rates of 7 Gbps and 20 Gbps respectively.

The publication “Direct intensity modulation and wireless data transmission characteristics of terahertz-oscillating tunneling diodes” by K. Ishigaki, et al. in Electronic Letters. 48 (10): 582 (2012) proposes the use of T-rays as bandwidth for data transmission. A 542 GHz signal resulted in a data transfer rate of 3 Gbps.

US20210041295A1 describes a terahertz (THz) sensor module for spectroscopy and imaging in a dynamic environment, in particular for detection of predetermined gas or chemical molecules. In an embodiment, a terahertz (THz) sensor module comprises: a THz emitter configured to emit a THz beam into an environment; one or more movable micro-electromechanical system (MEMS) micromirrors; and one or more MEMS motors or actuators coupled to the one or more MEMS micromirrors. The one or more MEMS motors or actuators are configured to move the one or more MEMS micromirrors to change a direction of the THz beam in the environment A THz receiver is configured to receive a reflection of the THz beam from a reflective object in the environment. When not being used for spectroscopy or imaging, the THz sensor module(s) can be repurposed for high-speed THz-based data communication applications.

WO 2021/025815A1 discloses a terahertz (THz) sensor module for spectroscopy and imaging in a dynamic environment. A terahertz (THz) sensor module comprises: a THz emitter configured to emit a THz beam into an environment; one or more movable micro-electromechanical system (MEMS) micromirrors; and one or more MEMS motors or actuators coupled to the one or more MEMS micromirrors. The one or more MEMS motors or actuators are configured to move the one or more MEMS micromirrors to change a direction of the THz beam in the environment. A THz receiver is configured to receive a reflection of the THz beam from a reflective object in the environment.

### SUMMARY OF THE INVENTION

It would be beneficial to enable an increase of the functionality of wireless transmitter devices operating in the mm-wave communication band and/or the THz communication band.

According to a first aspect of the invention, a wireless transmitter device is described. The wireless transmitter device comprises a signal provision unit configured to provide wireless communication signals in the mm-wave communication band or in the THz communication band or in both the mm-wave and the THz communication band, hereinafter referred to as mm-wave/THz-communication signals to one or more wireless receiver devices for data communication in accordance with a predetermined wireless communication protocol. The wireless transmitter device also comprises an operation-mode ascertaining unit configured to ascertain operation data indicative of at least one desired operation mode from a plurality of available operation modes of the wireless transmitter device, wherein the available operation modes include at least a communication operation mode for data communication between the wireless transmitter device and the one or more wireless receiver devices and a gas-sensing operation mode for sensing, using the mm-wave/THz-communication signals, a presence of a predetermined gas within a gas-sensing volume. The wireless transmitter device further comprises a signal-parameter determination unit that is connected to the operation-mode ascertaining unit and to the signal provision unit and that is configured to determine emission parameters of the mm-wave/THz-communication signals to be provided in dependence on the at least one desired operation mode. In the wireless transmitter device of the first aspect of the invention, the signal provision unit is further configured to provide mm-wave/THz-communication signals in accordance with the determined emission parameters.

The wireless transmitter device of the first aspect of the present invention is thus operable in a plurality of operation modes, each using the mm-wave/THz-communication signals, i.e., radiofrequency communication signals in the THz communication band, defined herewithin as the frequency range between 0.1 and 30 THz, wavelength range between 10 and 3000 μm, and/or in the mm-wave communication band, i.e., radiofrequency communication signals in the EHF band, defined herewithin as the frequency range between 30 and 300 GHz, wavelength range between 1 and 10 mm. These are characteristic frequency bands in which many absorption lines appear due to, in particular, rotational transitions of polar gas molecules. This absorption spectrum contains Lorentzian resonances at discrete frequencies and is unique to each gas molecule, which enables classification and recognition of gases, in particular polar gases, via THz spectroscopy for example.

Thus, one of the available operation modes is the communication operation mode for transmitting data to the one or more wireless receiver devices in accordance with a communication protocol and using the mm-wave/THz communication signals. Another available operation mode of the wireless transmitter device is the gas-sensing operation mode for sensing a presence of a predetermined gas or chemical molecule within a gas sensing area. The gas-sensing volume is that volume in which the presence or absence of such gases or chemical molecules affects the spectrum of the mm-wave/THz-communication signal. The operation-mode ascertaining unit is configured to ascertain operation data that indicates at least one desired operation mode from the plurality of available operation modes and the signal-parameter determination unit determines, based on the desired operation mode or modes, the emission parameters of the mm-wave/THz-communication signals that are to be emitted for operation in the desired operation mode. The signal provision unit is thus configured to provide mm-wave/THz-communication signals in accordance with the emissions parameters determined as a function of the desired.

The wireless transmitter device of the first aspect of the invention thus enables an enable an increase of the functionality of wireless transmitter devices by enabling the use of mm-wave/THz-communication signals for other purposes such as gas sensing within a gas-sensing volume. A novel orchestration scheme is provided, which enables gas/chemical molecules detection while ensuring a regular radio-communication using mm-wave/THz-communication signals.

In the following, embodiments of the first aspect of the invention will be explained.

In an embodiment, the mm-wave/THz-communication signals have a frequency selected in the range between approximately 0.3 THz and approximately 18 THz, preferably in the range between 0.3 THz and 8 THz, more preferably in the range between 0.3 THz and 3 THz.

In an embodiment, both the communication operation mode and the gas-sensing operation mode can be simultaneously selected as desired operation mode by suitable operation data indicative of both operation mode. In this particular configuration, the mm-wave/THz-communication signals used during the gas sensing operation mode also contain payload data that is to be provided to one or more wireless receiver devices.

In an embodiment, when the gas-sensing operation mode is the desired operation mode, but there is no current need for data transmission to the receiver device, the signal provision unit is configured to provide a dummy communication message with no relevant payload or a beacon message, for example for providing, in particular broadcasting, identifiers indicative of the wireless transmitter device to receiver devices located within reach.

In an embodiment, the gas-sensing operation mode is configured to detect one or more gases or chemical molecules from a list of detectable gases or molecules. To this purpose, the operation data is indicative of the one or more gases or chemical molecules whose presence within the gas-sensing volume is be detected. To this end, in an embodiment, the signal-parameter determination unit has access to a table associating each of the detectable gases or chemical molecules with their corresponding absorption frequencies, so that the emission parameters determined are such that the mm-wave/THz-communication signal is provided with frequency components matching the absorption frequencies of the selected gases whose presence is to be determined.

In an embodiment, the operation-mode ascertaining unit is configured to receive, via a dedicated wired or wireless input unit, the operation data from an external device or from a user. In another embodiment, the operation-mode ascertaining unit is alternatively or additionally configured to determine the operation data, in accordance, for example, with a predetermined algorithm or according to predetermined conditions. For instance, the operation data is time data indicative of respective time slots allocated to different operation modes.

In a preferred embodiment, the signal-parameter determination unit is configured to determine controllable emission parameters that include one or more of a transmission frequency of the mm-wave/THz-communication signal, a transmission direction of the mm-wave/THz-communication signal, a beam-form of the mm-wave/THz-communication signal, a polarization of the mm-wave/THz-communication signal or any combination thereof.

In particular, the transmission frequency or frequencies are selected as a function of the one or more gases or chemical molecules that are to be detected according to the received operation data. Each of these gases or molecules is associated to a respective maximum absorption spectrum. By transmitting the mm-wave/THz-communication signals only at those relevant frequencies, a power consumption of the wireless transmitter device will be improved, in comparison with a device that constantly scans across all theoretically possible gas sensing frequencies. The operation in which the wireless transmitter device provides the mm-wave/THz-communication signals only at those frequencies relevant with respect to the gas or gases to be detected is also referred to as sniff-mode operation.

The direction of the transmission of the mm-wave/THz-communication signals, as well as the shape of the beam of the transmitted mm-wave/THz-communication signals and the polarization of the electromagnetic signal are other controllable emission parameters. The inventors recognize that for a wireless transmitter device according to the invention, there are relevant requirements for the gas-sensing operation mode, especially when it comes to into which direction to best aim a THz/mm-wave beam within a given building space. Thus, for performing the gas-sensing operation mode it is desired to minimize the spatial diversity of multipaths. Particularly, it is advantageous that in the gas-sensing operation mode, the signal provision unit is configured such that the wireless energy of the mm-wave/THz-communication signal is deliberately directed either directly to the wireless receiver device, if this is located within a line or sight, or to direct it at one of the rooms surfaces which delivers a strong single reflection to a corresponding wireless receiver device. If the transmitter device and receiver device are co-located within the unit, the strong single-path reflection may be obtained by transmitting a directional mm-wave/THz-communication signal towards a highly reflective surface preferably under a 90 degree angle, hence resulting in a high amount of the reflected energy directly coming back to the unit via a direct path without any further reflections elsewhere in the room and thereby ensuring the maximum possible S/N ratio for the gas-sensing operation mode.

Thus, in another embodiment, the wireless transmitter further comprises an environment-data ascertaining unit configured to ascertain environment-data indicative of a location of the wireless transmitter device and of the one or more wireless receivers and indicative of elements in the surroundings or vicinity of the wireless transmitter and/or the wireless receiver device, which affect the provided mm-wave/THz-communication signal in detectable manner, and that may include, for instance, information about the materials in the room, in particular the walls, ceilings, floors, columns and any other constructive element that may block or otherwise alter the signal path by reflecting or absorbing the energy of the signal. In this embodiment, the signal-parameter determination unit is further configured to determine, using the ascertained environment-data, a respective set of emission parameters associated to each available operation modem, and the signal provision unit is configured to provide the mm-wave/THz-communication signals using the set of emission parameters associated to the desired operation mode. In particular, 3D models of the room can be provided as environment-data based upon which the different sets of emission parameters can be determined. These 3D models can for instance be provided by a building manager or obtained using augmented reality devices. Image data and/or LIDAR data are in some embodiments used as environmental data in order to determine the location of the transmitter and receiver devices as well as the material of the surfaces in the surroundings.

In a particular embodiment, and for ascertaining the environment-data, the environment-data ascertaining unit is configured to receive environment-data via a data input. The data input may comprise a 3D model of the environment, an image data of the environment, LIDAR data, a radiofrequency data, and any other data type which may help in identifying a location of the wireless transmitter device and of the one or more wireless receiver devices and/or indicative of elements in the surroundings of the wireless transmitter device and/or the wireless receiver device. The data input may be received via a user or via an external source. Additionally, or alternatively, in another embodiment, and for ascertaining the environment-data, in particular in a commissioning phase of the wireless transmitter device after it has been installed at the location of operation, the environment-data ascertaining unit is configured to control provision of mm-wave/THz-communication signals with varying emission parameters, to receive, from the one or more wireless receiver devices signal-reception data, indicative of the received mm-wave/THz-communication signal, and to determine the environment-data based on the respective emission parameter and the resulting signal-reception data. Thus, during said commissioning phase, the wireless transmitter device provides mm-wave/THz-communication signals with different emission parameters, in particular direction of transmission and beam-form, preferably in a scanning mode, where the parameters are changed stepwise. The environment-data ascertaining unit of the wireless transmitter device is configured to receive, from the wireless receiver devices, the signal-reception data that is for instance indicative of the signal parameter indicative of a quality of the received signal, for example a signal strength, or a channel state indicator, or of the received beam-form, or of the received frequency or frequency spectrum, or any other suitable signal parameter that can be associated to a relative location between transmitter device and receiver device, or to the surroundings, for example the material of the walls, floor or ceiling in a given room or any other characteristic thereof that has a detectable influence on the behavior of the travelling mm-wave/THz-communication signals such as, for instance, the presence and/or content of moisture on a given surface or in the air.

In another embodiment, the environment-data ascertaining unit is additionally or alternatively configured to ascertain environment-data indicative of presence of people and/or animals within a predetermined volume. This is in a particular embodiment performed by tracking UWB beacons emitted by portable or wearable devices, such as mobile phones.

The functionality of the wireless transmitter device of the third aspect of the invention can be further increased by enabling other available operation modes that are selectable by means of the received operation data. For example, in a particular embodiment according to the invention, the available operation modes further include an activity-sensing operation mode for sensing, using the mm-wave/THz-communication signals, presence and/or motion and/or vital signs of one or more person and/or animal within an activity-sensing volume. This is performed using radio-frequency based sensing techniques with the transmitted mm-wave/THz-communication signals. The signal-parameter determination unit is further configured to determine the emission parameters according to which to the signal provision unit has to provide the mm-wave/THz-communication signals for performing the activity-sensing operation mode. In an embodiment, the desired operation mode can be a combination of any of the previously described available operation modes, for instance, data-communication mode together with gas-sensing operation mode for sensing CO2 and activity sensing operation mode for sensing presence of people in the activity-sensing volume. The signal-parameter determination unit, given the desired operation mode, determines the optimal emission parameters for said desired operation mode and the signal provision unit provides the mm-wave/THz-communication signals in accordance with the determined emission parameters. The activity-sensing volume, as well as the gas-sensing volume, depend on the path of the mm-wave/THz-communication signals and thus on the selected emission parameters. The gas-sensing and the activity-sensing volumes are defined as those regions of space where the presence of gases or the activity of a subject have a measurable impact in the mm-wave/THz-communication signals that can be correlated to said gases or activities.

In yet another embodiment, the available operation modes of the wireless transmitter device according to the invention additionally or alternatively include a wireless-charging mode for wirelessly charging a wireless receiver device, using the mm-wave/THz-communication signals. For example, a device such as a mobile phone, a sensor or a switch, which include a battery, and in signal communication with the wireless transmitter device, may directly or indirectly via a network control device, provide a request to have its battery charged. This request is received by the wireless transmitter device as operation data indicative of wireless-charging mode for that device. Preferably, using environment-data indicative of the relative position of that device to be charged, the signal-parameter determination unit determines the emission parameters necessary (e.g., frequency, directions, beam-form, signal power) to provide charging power via the mm-wave/THz-communication signal. Additionally or alternatively, the operation data is indicative of a need to provide power to a given device, and the mm-wave/THz-communication signal provided with the determined emission parameters is used to power said device, which does not necessarily need a battery.

In an embodiment, the wireless transmitter device of the first aspect of the invention further comprises a receiving unit for receiving mm-wave/THz-communication signals. In other words, the transmitter device is configured as a transceiver device that also includes a receiving unit and wherein said receiving unit is configured as one of the wireless receiver devices. In this particular embodiment, when operating in the gas-sensing operation mode, the sensing may be configured such that the wireless energy emitted by the transmitter device is deliberately directed at one of the rooms surfaces which delivers a strong single reflection to the receiving unit, for instance, transmitting a directional mm-wave/THz-communication signal towards a highly reflective building surface preferably under a 90 degree angle, hence resulting in a high amount of the reflected energy directly coming back to the receiving unit via a direct path without any further reflections elsewhere in the room and thereby ensuring the maximum possible S/N ratio for the received mm-wave/THz-communication signal.

The wireless transmitter device further comprises a gas sensing unit connected to the receiver unit and configured to, when the operation data is indicative of the gas-sensing operation mode, the determine spectral data indicative of a spectral content of the received mm-wave/THz-communication signals and to determine the presence of predetermined gases in a gas-sensing volume using the spectral data. Additionally, in another embodiment, the wireless transmitter further comprises an activity sensing unit, connected to the receiver unit and configured to, when the operation data is indicative of the activity-sensing operation mode, determine signal quality data of the mm-wave/THz-communication signals, the signal quality data indicative of a received signal strength or a channel state of a communication link between the transmitter device and the receiver device, or any other suitable signal metric for determining an activity of one or more subjects, and to determine a current activity the one or more subjects within an activity sensing volume using the signal quality data.

In a preferred embodiment, when the ascertained operation data is indicative of a gas-sensing operation mode, i.e. the desired operation mode includes a gas-sensing operation mode of one or more gases or molecules, the signal-parameter determination unit is configured to determine emission parameters that result in a direct or reduced multipath signal trajectory between the wireless transmitter device and one of the one or more wireless receiver devices. As stated above, radio waves, including mm-wave/THz-communication signals, are propagated through electromagnetic radiation and interact with the building surfaces by reflection, refraction, diffraction, absorption, polarization, and scattering. Depending on the spatial orientation, polarization, and beam-cross-section of the transmitted radio beams of the mm-wave/THz-communication signals with respect to the orientation & materials of the building surfaces present in the room, a different multipath environment within the room is created.

According to a second aspect of the present invention, a wireless communication arrangement is described. The wireless communication arrangement comprises at least one wireless transmitter device according to the first aspect of the present invention and at least a wireless receiver device in wireless data communication with the wireless transmitter device. The wireless receiver device comprises an operation-mode ascertaining unit configured to ascertain operation data indicative of at least one desired operation mode from a plurality of available operation modes of the wireless transmitter device. The receiver device also comprises a receiver unit configured to receive the mm-wave/THz-communication signals, a functional unit connected to the receiver unit and being operable in accordance with operation instructions transmitted by the wireless transmitter device via the mm-wave/THz-communication signals, a gas sensing unit connected to the receiver unit and configured to, when the operation data is indicative of the gas-sensing operation mode, the determine spectral data indicative of a spectral content of the mm-wave/THz-communication signals and to determine the presence of predetermined gases in a gas-sensing volume using the spectral data.

In a particularly advantageous embodiment of the wireless communication arrangement of the second aspect of the invention, the wireless communication arrangement is a wirelessly controllable lighting arrangement that comprises lighting devices, sensors, switches and optionally a hub, bridge or other type of network control device, that exchange data using mm-wave/THz-communication signals. The lighting devices comprise a functional unit, for instance a lighting unit, that is controllable based on data received wirelessly, for example from a switch, a sensing device, or from the network control unit. However, and depending on the ascertained, (e.g., received or determined) operation data, the receiver device can additionally or alternatively perform a gas-sensing function using the mm-wave/THz-communication signals provided with an appropriate set of emission parameters by the wireless transmitter device.

In a preferred embodiment according to the second aspect of the invention, the wireless receiver further comprises an activity sensing unit, connected to the receiver unit and configured to, when the operation data is indicative of the activity-sensing operation mode, determine signal quality data of the mm-wave/THz-communication signals, the signal quality data indicative of a received signal strength or a channel state of a communication link between the transmitter device and the receiver device, and to determine a current activity of one or more subjects within an activity sensing volume using the signal quality data. Thus, depending on the ascertained, (e.g., received or determined) operation data, the receiver device can additionally or alternatively perform an activity-sensing function using the mm-wave/THz-communication signals provided with an appropriate set of emission parameters by the wireless transmitter device. The activity-sensing function may comprise a presence sensing function, a movement sensing function or a vital-sign sensing function, each with a respective set of emission parameters. Vital sign sensing function may include, for example breathing sensing and/or heartbeat sensing.

In state-of-the-art IoT applications (e.g. offices), various gas sensors are used for enabling a gas-sensing operation mode, for instance to report the local carbon dioxide level in different rooms. Similarly, gas sensors are employed for detecting smoke and/or dangerous gases caused by a fire such as carbon monoxide (CO) or hydrogen cyanide (HC). However, today's conventional gas sensor technologies (e.g., metal-oxide gas sensors, electrochemical gas sensors) can detect a few gases but have several disadvantages. For example, integrating a gas sensor in a lamp or lighting device requires an aperture or opening to allow air to flow onto the gas sensor so that the gas can be detected. However, the design of an aperture into a lighting device poses several challenges. The aperture may degrade water resistivity of the lighting device fixture, for instance for a waterproof industrial-lighting luminaire. In addition, the size of the aperture may be constrained due to a trade-off between design of the light fixture and gas detection capability (e.g. for a sleek suspended office luminaire) as well as dust accumulation (e.g. in industrial manufacturing settings). In addition to aperture constraints, the number of gases detected by a given luminaire-integrated sensor is limited. Integrating multiple gas sensors on the luminaire to detect different gases would increase the size and cost of the lighting device. It is therefore advantageous and attractive to integrate a mm-wave/THz sensor module inside the lighting device. The same mm-wave/THz sensor module allows the lighting device to support mm-wave/THz spectroscopy for gas sensing in the gas-sensing unit, as well as activity sensing (occupancy detection, movement sensing and vital sign monitoring) in an activity-sensing unit. With a mm-wave/THz sensor module, there is no need for an aperture on the lighting device to perform gas sensing, for instance.

In the following, different embodiments of a wireless communication arrangement, in particular of a wireless lighting arrangement installed in a building will be described.

In a wireless communication arrangement, such as a lighting arrangement, capable of performing a gas sensing operation and an activity sensing operation in addition to regular radio communication, there is typically a trade-off between the different sensing functions regarding which sensing frequency to utilize, where within the building-space the transmitter device aims its mm-wave/terahertz radio beam in the form of mm-wave/THz-communication signal, which wireless path length to aim for, which cross-section of the radio beam is used (transmission- and/or reception-beamforming). Thus, a multi-mode wireless communication arrangement provides the inventive capability of orchestrating passive RF sensing firstly for gas detection as well as secondly for activity detection while thirdly still ensuring the regular radio-communication tasks of the arrangement.

Alternatively, an embodiment of a hybrid wireless communication arrangement is advantageously configured to semi-concurrently employ a first RF-based sensing mode (i.e. using the mm-wave/THz-communication signals) optimized for activity sensing and a second RF-based sensing mode for sensing gases (e.g. CO2) or ion concentration levels in the room's air. The ions may for instance be released by a needle point ionizer for air disinfection purposes.

According to the invention, for a hybrid wireless communication arrangement capable of sensing gas and sensing activity using the mm-wave/THz-communication signals, there are key differences between the requirements for the gas-sensing operation mode and the activity-sensing operation mode-especially when it comes to into which direction to best aim a mm-wave beam within the building space: For activity detection, creating a rich multipath environment throughout the space is desired while for performing gas sensing it is desired to minimize the spatial diversity of multipaths. It is therefore advantageous that, in such a hybrid arrangement, for the gas-sensing mode, the emission parameters are determined such that the wireless energy emitted by the signal provision unit is deliberately directed directly to the wireless receiver or at one of the room's surfaces that delivers a strong single reflection to wireless receiver device, comprising the gas-sensing unit. If the transmitter and the receiver are co-located within the same lighting device, the strong single-path reflection may be obtained by transmitting a directional RF sensing signal, i.e. the mm-wave/THz-communication signal, towards a highly reflective building surface preferably under a 90 degree angle, hence resulting in a high amount of the reflected energy directly coming back to the lighting device via a direct path without any further reflections elsewhere in the room and thereby ensuring the maximum possible S/N ratio for an RF-based gas-sensing algorithm used by the gas-sensing unit to determine the presence of a certain gas or chemical molecule in the gas-sensing volume.

On the other hand, for the activity-sensing operation mode, the signal-parameter determination unit of the wireless transmitter device of the hybrid wireless communication arrangement preferably determines the emission parameters such that the electromagnetic signal (i.e. the mm-wave/THz-communication signal) is reflected at a slanted surface and thereby creates a rich multipath environment within the room.

Optionally, to ensure sufficient signal quality of regular mm-wave-based radio-communication using the mm-wave/THz-communication signals (e.g. for sending lighting control commands between a first and a second device of the wireless lighting arrangement), the integral electromagnetic energy arriving from the first transmitting luminaire, i.e. the transmitter device, at the second (or the third) luminaire receiving the lighting controls command must be sufficiently high to ensure an acceptable signal quality of the control command of the communication operation mode. Hence, if for radio-communication no direct line-of-sight path between the transmitter device, i.e. the first luminaire, and second luminaire is available, for the communication task the mm-wave beam is transmitted by the first luminaire using selected emission parameters that result in the mm-wave/THz-communication signal being preferably directed to a building surface which result in a strong single reflected beam aiming directly towards the second luminaire without excessive refraction, diffraction, absorption, polarization, or scattering by other building surfaces. However, in the latter case, if the gas-sensing operation mode is part of the desired operation mode, the gas-sensing operation mode (if performed by a transmitter/receiver device both co-located in the first luminaire) inevitably will suffer from deteriorated S/N ratio as only little electromagnetic energy is reflected backwards to the first luminaire, hence causing a problem for the first luminaire's gas sensing accuracy.

The determination of the emission parameters may take into account that, unlike for activity sensing such as human vital sign detection, for RF-based gas sensing of gases not much spatial granularity is required. This is due to gas concentrations (e.g. CO2) quickly averaging out across typical indoor building spaces. Hence, from an application perspective the hybrid wireless communication arrangement can choose location of the air volume wherein the gas sensing is to be performed, i.e. the volume where a presence of the predetermined gas would influence in a detectable manner the mm-wave/THz-communication signal, rather flexibly. Hence, in an embodiment, the signal-parameter determination unit first determines the emission parameter for covering the to-be-monitored sensing volume solely based on the needs of the activity-sensing operation mode, such as human vital sign detection (e.g. breathing detection); subsequently the gas-sensing volume for the gas sensing (e.g. between a given pair of lighting devices, one acting as a transmitter device and the other as a receiver device) is determined based on the multipath needs for the gas-sensing operation mode.

In another embodiment of the wireless communication arrangement, the emission parameters determined for a desired operation mode that includes the gas-sensing mode and the activity-sensing mode depend on a desired type of human-activity-detection to be performed by the wireless communication sensing system. For instance, if breathing detection is desired while multiple persons are present in the room, the mm-wave/THz-communication signal should be spatially confined to determine the small breathing-related chest movement of the first person while keeping the electromagnetic radiation as much as possible away from the second person in the room. For the gas detection function using mm-wave/THz-communication signals any human movements can be easily filtered out from the time series spectral data the gas-sensing algorithm employed by the gas-sensing unit; consequently, for gas sensing, the mm-wave/THz-communication signal may pass in proximity of humans without any negative consequences on the gas sensing accuracy. Thus, in an embodiment, in case of reception of operation data indicative of a gas-sensing operation mode and an activity-sensing operation mode involving for example breath or heartbeat detection in a room with a more than one person, the signal-parameter determination unit is configured to determine emission parameters corresponding to a direction of the emitted mm-wave/THz-communication signal to (A) restrict the richness of multipaths (for sufficient signal strength for the gas-sensing operation mode) as well as (B) simultaneously confining the electromagnetic energy of the mm-wave/THz-communication signal away from the room portion occupied by second person (for ensuring accurate breathing detection of the first person).

In another embodiment, the gas-sensing function may be realized with a transmitter device and a receiver device co-located inside the same lighting device. In this embodiment, the wireless communication arrangement may request via a user-input (UI), information about which gases the user is interested to monitor. This can be for instance remotely via a user device, such as a smartphone running a suitable app, wirelessly connected to the wireless communication arrangement, for example via the network control device. The arrangement, for example, the network control unit, then ascertains the unique and maximum absorption spectra for these user-defined target gases and defines a set of gas-sensing frequencies which jointly are capable of covering all target gases reasonably well. In another embodiment, the target gases are indicated by external systems, such as air-pollution monitoring stations outside the room. The signal-parameter determination unit uses this information to determine the suitable emission parameters. Hence, thanks to the end-user input, or input from external systems, rather than constantly scanning across all theoretically possible gas sensing frequencies, the wireless transmitter device may operate in a “sniff mode” where mm-wave/THz-communication signals are only transmitted at certain discrete frequencies; this will improve the power consumption of the wireless transmitter device. After the suitable and relevant gas-sensing frequencies have been determined, the wireless transmitter device re-configures the activity-sensing mode to be able to reuse the radio frequencies to be used by the gas sensing function. For instance, the choice of a first sensing frequency for the transmission of the mm-wave/THz-communication signal imposed by the choice of the gas-sensing operation mode may result in a reduction in the spatial radio-signal range for the activity-sensing operation mode (e.g. as at this chosen first sensing frequency, the electromagnetic waves are getting strongly absorbed in mid-air). Therefore, the wireless transmitter device is advantageously configured to re-assign for the activity-sensing operation mode another wireless receiver device, e.g. a wirelessly controlled luminaire that is located in closer proximity of both the wireless transmitter device and the activity-sensing volume.

Typically, the determination of an activity of a subject by an activity-sensing unit and the determination of a presence of a gas or a chemical molecule in the air by the gas-sensing unit require two distinctly different RF-based sensing algorithms. In some embodiments, running two algorithms in parallel may however overwhelm the computing resources of a single resource-constrained receiver device, e.g. a lighting device of the wireless communication arrangement. In this embodiment, passive RF activity sensing is used for motion sensing (i.e. using a first transmitting luminaire as the wireless transmitter device and a second receiving luminaire as the wireless receiver device running the activity sensing unit) while simultaneously combining it with a radar-like mode for gas sensing (i.e. with the transmitter device and the receiver device running the gas sensing unit both co-located in the same luminaire). The first advantage of this architecture is that the computation for the gas sensing unit runs on the first luminaire, i.e., the transmitter device while the RF sensing algorithms for the activity sensing is computed on the second luminaire (i.e. by a separate microcontroller from the gas sensing unit); this particular architecture hence alleviates the computing constraints of the wireless communication arrangement. The second advantage of this hybrid passive-RF (transmitter and receiver in different devices) & radar (transmitter and receiver in the same device) architecture is that the same mm-wave/THz-communication signals can be shared by both the gas-sensing mode and the activity sensing mode thereby reducing wireless congestion within the room.

Within the wireless communication arrangement, the path length of the mm-wave/THz-communication signals can be easily determined via time-of-arrival measurements. Generally, the longer the path length, the more of the gas-related absorption loss is incurred by the mm-wave/THz-communication signal and the better the presence of a gas can be determined by the gas-sensing unit. In a given volume, the path length in the air can be increased by using multiple reflections off different building surfaces at different angles of incidence. Similarly, for a given path length, choosing a higher transmission frequency (e.g. 100 GHz) will by definition result in increased path loss in the air medium as compared to a lower transmission frequency (e.g. 60 GHz). Hence, for gas-sensing operation mode, the combination of transmission frequency and path length (i.e. a function of the direction of transmission and the surroundings) will determine the amount of absorption signal loss of the on the mm-wave/THz-communication signal. The fingerprint of the observed absorption loss can be matched with the known absorption signatures of a specific gas. If for a given set of emission parameters insufficiently strong absorption loss is determined, it may be beneficial to adjust the beam direction to increase the path length i.e., the total distance travelled by the TH-communication signal in free-space air, before it arrives from the transmitter device to the receiver device).

However, if for another set of emission parameters a higher transmission frequency is used in conjunction with an overly long path length, the performance of the gas sensing unit may deteriorate; for instance, the absorption signature peak of the to be detected gas may fall below noise floor of the receiver device which makes it impossible for the gas sensing unit to determine the type of gas.

In one embodiment, in order to determine the optimal combination of path length and transmission frequency for the gas-sensing operation mode, a first step is performed during the configuration of the gas-sensing unit that includes a mm-wave scan of the full room. During this scan, the transmitter device sequentially transmits mm-wave/THz-communication signals as gas-sensing wireless “radar” signals in all spatial directions into the room and creates a data structure of gas sensing signal strength vs mm-wave/THz scan angle. Based on the received mm-wave/THz-communication signals, the optimum set of emission parameters is identified—for this specific room scanned-; in particular, the beam orientation for the gas sensing resulting in the highest received signal strength. For instance, the system may empirically identify that the best possible transmission angle for gas sensing in the room is achieved when the transmitter device transmits at 30 degree downwards angle towards the north-east direction, as this emission parameter results at a strong gas-sensing signal received at one of the wireless receiver devices.

In a room, there may be several ways how to realize the desired path length for the gas-sensing operation mode. For the case that a wireless communication arrangement implemented as a hybrid occupancy/gas sensing system is used, the set of emission parameters used to provide the mm-wave/THz-communication signals is chosen as that one specific multipath which in addition to being suitable for gas sensing also provides the highest sensitivity to activity sensing in the sensing volume. Consequently, both the gas-sensing operation mode as well as the activity-sensing operation mode will be well covered by the multipath chosen by the transmission device. As the location of the human activity in the room may change over time, an embodiment of the transmission device is advantageously configured to re-adjust in real time the direction of transmission for optimized gas-sensing and/or activity-sensing performance.

The coordinated choice of the direction of transmission or transmission beam angle firstly results in the optimal amount of wireless absorption by the gas, the need for digital signal processing of the spectral data for gas-sensing in order to remove or reduce noise is reduced, leading to reduced computation and power consumption of the receiver device. Secondly, the coordinated choice of the direction of transmission or transmission beam angle also assures reliable high quality activity sensing.

Additionally, or alternatively, in another embodiment, the wireless communication arrangement, in particular the receiver device may additionally be advantageously configured to distinguish between signal losses caused by the presence of the to-be-monitored gas and the inevitable signal losses related to the required reflections off the building surfaces. This can be estimated or determined using suitable environment data. Alternatively, to estimate the losses from the surface reflections, a user may be prompted to bring a wireless transmitter device or any other device capable of mm-wave/THz-communication signal transmission (e.g. 60 GHz Wi-Fi or 5G) within the proximity of the surface material to determine the reflection-related losses for the specific transmission frequency of interest. Alternatively, the type of surface materials may be determined by a panoramic scan (as readily available from LiDAR apps). Subsequently, the wireless transmitter device may be configured to deliberately choose a emission parameters that result in a multipath formed by a subset of building surfaces in the room which have been identified during the commissioning to hardly absorb the specific wireless frequency of interest for the gas sensing task at hand.

In particular, the use of mm-wave/THz radio frequencies is particularly convenient as many devices are configured to communicate via such frequencies. In particular 6G devices may, for instance, (partially) operate using THz frequencies. Hence, the receiver device may take advantage of hardware that is already present, such as in a lighting infrastructure, resulting in a reduction of the need for dedicated hardware, which may be more cost-efficient, space-efficient, and have a reduced carbon footprint.

According to a third aspect of the invention, a method for controlling operation of a wireless transmitter device is provided. The method comprises:
ascertaining operation data indicative of at least one desired operation mode from a plurality of available operation modes of the wireless transmitter device, wherein the available operation modes include at least a communication operation mode for data communication between the wireless transmitter device and the one or more wireless receiver devices and a gas-sensing operation mode for sensing, using the mm-wave/THz-communication signals, a presence of a predetermined gas within a gas-sensing volume; and
determining emission parameters of the mm-wave/THz-communication signals to be provided in dependence on the at least one desired operation mode; and
providing mm-wave/THz-communication signals to one or more wireless receiver devices for data communication in accordance with a predetermined wireless communication protocol and in accordance with the determined emission parameters.

The method of the third aspect thus shares the advantages of the wireless transmitter device in accordance with the first aspect of the present invention.

A fourth aspect of the present invention is formed by a method for controlling operation of a wireless communication arrangement that comprises at least one wireless transmitter device according and a wireless receiver device in wireless data communication with the wireless transmitter device. The method comprises
performing the steps of the method of the third aspect of the invention;
receiving the mm-wave/THz-communication signals;
operating a functional unit of the wireless receiver device in accordance with operation instructions transmitted by the wireless transmitter device via the mm-wave/THz-communication signals;
when the operation data is indicative of the gas-sensing operation mode, determining spectral data indicative of a spectral content of the mm-wave/THz-communication signals and determining the presence of predetermined gases in a gas-sensing volume based thereon; and optionally
when the operation data is indicative of the activity-sensing operation mode, determining signal quality data of the mm-wave/THz-communication signals, the signal quality data indicative of a received signal strength or a channel state of a communication link between the transmitter device and the receiver device, and determining a current activity of one or more subjects within an activity sensing volume using the signal quality data.

A fifth aspect of the invention is formed by a computer program product comprising instructions, which, when the program is executed by a computer, cause the computer to carry out the method of the third or the fourth aspect of the invention. It shall be understood that the wireless transmitter device of claim 1, the wireless communication arrangement of claim 11, the methods of claims 13 and 14, and the computer program of claim 15, have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows a schematic diagram of an embodiment of a wireless communication arrangement comprising a wireless transmitter device according to the invention and a wireless receiver device;

FIG. 2 show another schematic block diagram representing a wireless communication arrangement that includes a second embodiment of a wireless transmitter device according with the invention;

FIG. 3 shows a schematic block diagram of a wireless communication arrangement that includes a third embodiment of a wireless transmitter device in accordance with the invention;

FIG. 4 shows a flow diagram of an embodiment of a method according to the invention for controlling operation of a wireless transmitter device; and

FIG. 5 shows a flow diagram of an embodiment of a method according to the invention for controlling operation of a wireless communication arrangement.

### DETAILED DESCRIPTION OF EMBODIMENTS

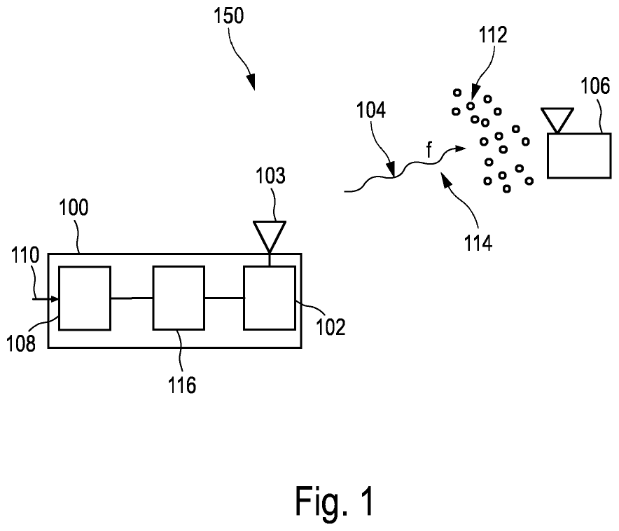

FIG. 1 shows a schematic diagram of a wireless communication arrangement 150 comprising a wireless transmitter device 100 and a wireless receiver device 106, both in signal communication in accordance with a predetermined wireless communication protocol based on mm-wave/THz-communication signals 104. The wireless transmitter device 100 comprises a signal provision unit 102 that is configured to provide, for example via an antenna 103, mm-wave/THz-communication signals 104 to the wireless receiver device 106 for data communication in accordance with the predetermined wireless communication protocol. The wireless transmitter also includes an operation-mode ascertaining unit 108 that is configured to ascertain, in this particular example, to receive, operation data 110 indicative of at least one desired operation mode from a plurality of available operation modes of the wireless transmitter device. The available operation modes include at least a communication operation mode for data communication between the wireless transmitter device 100 and the receiver device 106 and a gas-sensing operation mode for sensing, using the mm-wave/THz-communication signals 104, a presence of a predetermined gas, or chemical molecule 112 within a gas-sensing volume 114, for example based on the absorption spectrum associated to each of the detectable compounds. The wireless transmitter device 100 also comprises a signal-parameter determination unit 116 that is connected to the operation-mode ascertaining unit 108 and to the signal provision unit 102 and configured to determine emission parameters, for instance the transmission frequency, f, of the mm-wave/THz-communication signals 104 to be provided in dependence on the at least one desired operation mode. The signal provision unit 102 is further configured to provide mm-wave/THz-communication signals 104 in accordance with the determined emission parameters f. The emission parameters may comprise parameters related to or have an effect on the emission of the mm-wave/THz-communication signals.

Typically, the wireless transmitter device operates in the communication operation mode, in which the communication signals 104 in the mm-wave/THz communication band are provided to the wireless transmitter 106 or broadcasted, such as in the case of beacon signals. A user may require that the wireless transmitter device also operates in the gas-sensing operation mode, which is suitable for sensing the presence of gases or chemical molecules in the air, which due to its structure, absorb given frequencies of the electromagnetic radiation. For example, a user requires additional operation in a CO₂-sensing operation mode, by providing operation data indicative thereof to the operation-mode ascertaining unit 108. The signal-parameter determination unit is configured to select the emission parameters of the mm-wave/THz-communication signals, in particular their frequencies, such that the mm-wave/THz-communication signals includes frequency components that would be absorbed by the CO₂ molecules in the air if these were present within the gas-sensing volume.

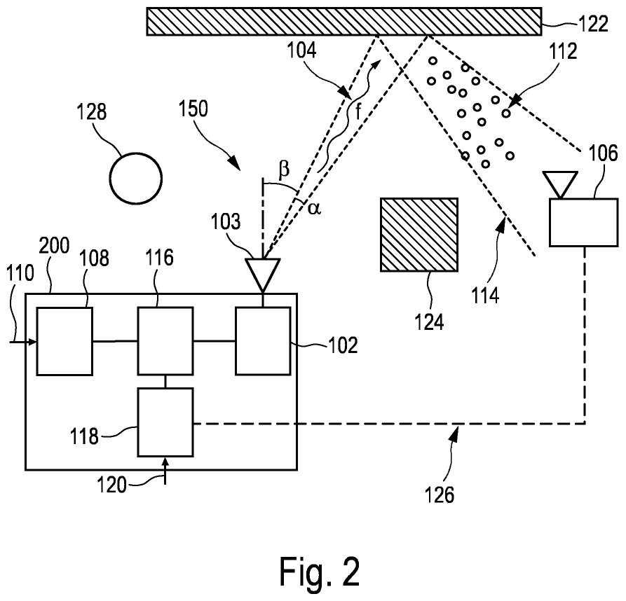

FIG. 2 show another schematic block diagram representing a wireless communication arrangement that includes a second embodiment of a wireless transmitter device 200 according with the invention. Those technical features of the wireless transmitter device 200 having identical or similar function as those in transmitter device 100 of FIG. 1 will be referred to using the same reference numbers for the sake of simplicity.

The wireless transmitter device 200 further comprises an environment-data ascertaining unit 118 that is connected to the signal-parameter determination unit 116 and configured to ascertain, in this particular example to receive, environment-data 120 indicative of a location of the wireless transmitter device 200 and of the wireless receiver device 106, for example a relative location between them or a respective location within a given room, and indicative of the surroundings, for example of the walls 122, columns or other objects present in the vicinity of the transmitter and the receiver devices, that may have an influence on the signal path of the mm-wave/THz-communication signals. The signal-parameter determination unit 116 is further configured to determine, using the received environment-data 120, a respective set of emission parameters f, α, β associated to each available operation modes. As in the case of the wireless transmitter device 100 of FIG. 1, the signal provision unit 102 is configured to provide the mm-wave/THz-communication signals 104 using the set of emission parameters (e.g., f, α, and β, but also polarization, signal power and other suitable controllable emission parameters) associated to the desired operation mode.

The controllable emission parameters of the present example include the transmission frequency f of the mm-wave/THz-communication signal 104, which is selectable depending on the gas or molecule 112 whose presence is to be determined in accordance with the operation data, a transmission direction of the mm-wave/THz-communication signal 104, characterized in this simplified two dimensional representation by the angle β, a beam-form of the mm-wave/THz-communication signal characterized in this simplified two dimensional representation by the angle α. The transmission direction and the beam-form are determined using the environment-data 120 to ensure that the path followed by the mm-wave/THz-communication signal is suitable for the desired operation mode. For instance, a desired operation mode where one communication operation mode is selected, may involve other frequencies, and, for example in the case of broadcasting beacon signals, a broader beam-form, e.g. a larger value of the angle α. When the desired operation consists or includes the gas-sensing operation mode, it is advantageous that the signal provision unit 102 is configured such that the wireless energy of the mm-wave/THz-communication signal 104 is deliberately directed either directly to the wireless receiver device 106, if this is located within a line or sight, or to direct it at one of the rooms surfaces 122 which delivers a strong single reflection to the corresponding wireless receiver device. In the example shown in FIG. 2, the direct line-of sight is blocked by column 124. This information is readily available based on the ascertained environment data 120, and thus, the signal-parameter determination unit 116 determines the direction of transmission and the beam form, such that gas-sensing is possible by RF-based sensing between the wireless transmitter device 200 and the wireless receiver device 106 using the mm-wave/THz-communication signals. In particular, the environment-data can be in the form of data indicative of 3D models of the room. These 3D models can for instance be provided by a building manager or obtained using augmented reality (AR) devices. Image data and/or LIDAR data can be also used as environmental data 120 in order to determine the location of the transmitter and receiver devices as well as the material of the surfaces in the surroundings. Preferably, when the ascertained operation data 110 is indicative of a gas-sensing operation mode, the signal-parameter determination unit 116 is configured to determine emission parameters that result in a direct or reduced multipath signal trajectory between the wireless transmitter device 200 and one of the one or more wireless receiver devices 106.

Additionally, or alternatively, the wireless transmission device can be operable in a commissioning phase, in particular after installation in the location of operation, during which the environment-data ascertaining unit 118 is configured to control provision of mm-wave/THz-communication signals 104 with varying emission parameters, in particular transmission direction and beam form, to receive, from the wireless receiver device 106, signal-reception data 126 indicative of the received mm-wave/THz-communication signal, and to determine the environment-data based on the respective emission parameter and the resulting signal-reception data 126. Thus, during said commissioning phase, the wireless transmitter device provides mm-wave/THz-communication signals 104 with different emission parameters, in particular direction of transmission β and beam-form α, preferably in a scanning mode, where the parameters are changed stepwise. The environment-data ascertaining unit 118 of the wireless transmitter device 200 is configured to receive, from the wireless receiver device 106, either directly or via another device such as a network control unit, the signal-reception data 126 that is for instance indicative of the signal parameter indicative of a quality of the received signal, for example a signal strength, or a channel state indicator, or of the received beam-form, or of the received frequency or frequency spectrum, or any other suitable signal parameter that can be associated to a relative location between transmitter device and receiver device, or to the surroundings, for example the material of the walls, floor or ceiling in a given room.

Preferably, the wireless transmitter devices 100, 200 of FIG. 1 and FIG. 2 further include an activity-sensing operation as an available operation mode. The activity sensing mode is suitable for sensing, using the mm-wave/THz-communication signals, presence and/or motion and/or vital signs of one or more person within a sensing volume, using RF-based sensing techniques and procedures already known to the person skilled in the art. Also preferably, in the wireless transmitter device 200 the environment-data ascertaining unit is further configured to ascertain environment-data 120 indicative of presence of people 128 within a predetermined volume. Thus, the signal-parameter determination unit 116 is further configured to determine emission parameters (f, a, B) of the mm-wave/THz-communication signals 104 to be provided in a desired operation mode that consists of or comprises the activity-sensing operation mode. For the activity-sensing operation mode, the wireless transmitter device preferably provides the mm-wave/THz-communication signals with emission parameters that cause the mm-wave/THz-communication signal to reflect on a slanted surface, thereby creating a rich multipath environment within the room.

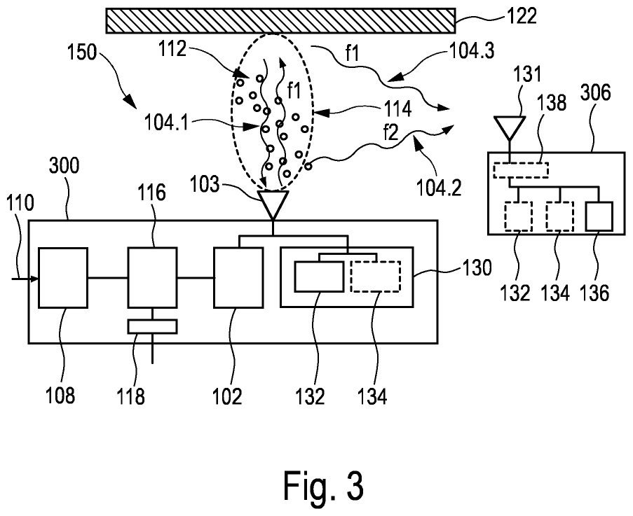

FIG. 3 shows a schematic block diagram of a wireless communication arrangement 150 that includes a third embodiment of a wireless transmitter device 300 in accordance with the invention. Those technical features of the wireless transmitter device 300 having identical or similar function as those in transmitter device 100 of FIG. 1 and/or those in transmitter device 200 of FIG. 2 will be referred to using the same reference numbers for the sake of simplicity. The wireless transmitter device 300 further comprises a receiving unit 130 for receiving mm-wave/THz-communication signals 104.1. The wireless transmitter device 300 can be referred to as a wireless transceiver device. The wireless transmitter device 300 further comprises a gas sensing unit 132 connected to the receiver unit and configured to, when the operation data is indicative of the gas-sensing operation mode, the determine spectral data indicative of a spectral content of the mm-wave/THz-communication signals 104.1 and to determine the presence of predetermined gases 112 in the gas-sensing volume 114 using the spectral data. The wireless transmitter device 300 may also comprise, as indicated by the dotted line, an activity sensing unit 134, connected to the receiver unit and configured to, when the operation data is indicative of the activity-sensing operation mode, determine signal quality data of the mm-wave/THz-communication signals 104.1, the signal quality data being indicative of a received signal strength or a channel state of a communication link between the transmitter device and the receiver device or of any other signal quality metric correlatable to a given activity of the subject within the activity sensing volume, and to determine a current activity of one or more subjects within the activity sensing volume using the signal quality data.

In FIG. 3, the wireless transmitter device 300 is shown operating in according to different desired operation modes. The wireless transmitter device 300 operated in a radar-like mode when the received operation data 110 is indicative of a gas-sensing operation mode, in particular when is indicative of only a gas-sensing operation mode. The receiver unit is co-located within the transmitter device and the strong single-path reflection that is beneficial for the gas-sensing operation mode is obtained by transmitting a directional mm-wave/THz-communication signal towards a highly reflective surface 122 preferably under a 90 degree angle, hence resulting in a high amount of the reflected energy 104.1 directly coming back to the unit via a direct path without any further reflections elsewhere in the room and thereby ensuring the maximum possible S/N ratio for the gas-sensing operation mode at a frequency band f1 where the gas or the chemical molecules are detectable. If the desired operation mode also includes the communication operation mode with the wireless receiver device 306, the signal-parameter determination unit determines the emission parameters so that enough signal power of the mm-wave/THz-communication signal of frequency f1104.3, for example after a reflection at the wall 122 reaches the wireless receiver device 306 for transmitting the payload information required. If the operation data is indicative of only communication-operation mode with receiver device 306, the signal-parameter determination unit determines the emission parameters that result in a direct communication between the wireless transmitter device 300 and the wireless receiver device, without the frequency constraint imposed by the frequency f1 required to sense the presence of gas 112. Thus, the mm-wave/THz-communication signal 104.2 can be provided at any suitable frequency, such as f2. Additionally, the wireless receiver device 106 may also comprise a-a gas sensing unit 132 and/or an activity sensing unit 134 as described above for performing a gas-sensing function or an activity-sensing function, both using the mm-wave/THz-communication signals provided by the wireless transmitter device. Signal 104.2 can be for example a wireless charging signal, sent in response to operation data indicative of a wireless-charging mode for the receiver device 306 (e.g., a sensor, a switch, or a battery-driven lighting device of the lighting arrangement or another device, such as a mobile phone, in communication with the lighting arrangement). The necessary frequency of the mm-wave/THz-communication signal as well as the direction of the transmission, the beam-form and the power are determined by the signal-parameter determination unit 116, preferably, using environment-data indicative of the relative position of that device to be charged.

The wireless communication arrangement 150 shown in FIG. 3 is in particular a wirelessly controllable lighting arrangement that includes wirelessly controllable lighting devices as well as sensors, switches and other related devices, all in communication using the mm-wave/THz-communication signals. The receiver device 306 of FIG. 3 is a lighting device and the transceiver device 300 is, for example, a network control unit, such as a hub, bridge, gateway, router, etc., or another lighting device. The lighting device 306 has a receiver unit that is configured to receive the mm-wave/THz-communication signals 104.2, 104.3 and a functional unit 136, such as a lighting unit, connected to the receiver unit 131 and being operable in accordance with operation instructions transmitted by the wireless transmitter device 300 via the mm-wave/THz-communication signals 104.2, 104.3. The operation instruction transmitted as payload to the receiver device may include instructions for turning-on or of the lighting unit, controlling the light intensity, color or temperature and other relevant instructions. It can also include a request to provide device status information. The lighting device 306 may also comprise, as explained above, a gas-sensing unit 132 and an activity-sensing unit, both connected to the receiver unit 131. The lighting device optionally comprises an operation-mode ascertaining unit 138 configured to ascertain operation data indicative of at least one desired operation mode from a plurality of available operation modes of the wireless transmitter device. The operation data can be provided by the transmitter device 300 or by a user directly to the lighting device 306. In other examples, the operation data is included as payload in the mm-wave/THz-communication signal 104.2, 104.3 and can be received and interpreted either by the operation-mode ascertaining unit 138 or directly by the gas-sensing unit 132 and/or the activity-sensing unit 134.

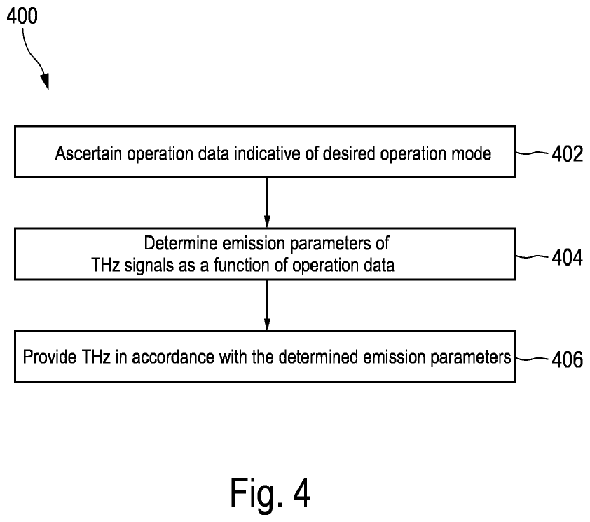

FIG. 4 shows a flow diagram of an embodiment of a method 400 for controlling operation of a wireless transmitter device. The method comprises, in a step 402, ascertaining operation data indicative of at least one desired operation mode from a plurality of available operation modes of the wireless transmitter device, wherein the available operation modes include at least a communication operation mode for data communication between the wireless transmitter device and the one or more wireless receiver devices and a gas-sensing operation mode for sensing, using the mm-wave/THz-communication signals, a presence of a predetermined gas within a gas-sensing volume. The method further comprises, in a step 404, determining emission parameters of the mm-wave/THz-communication signals to be provided in dependence on the at least one desired operation mode. The method also comprises, in a step 406, providing mm-wave/THz-communication signals to one or more wireless receiver devices for data communication in accordance with a predetermined wireless communication protocol and in accordance with the determined emission parameters.

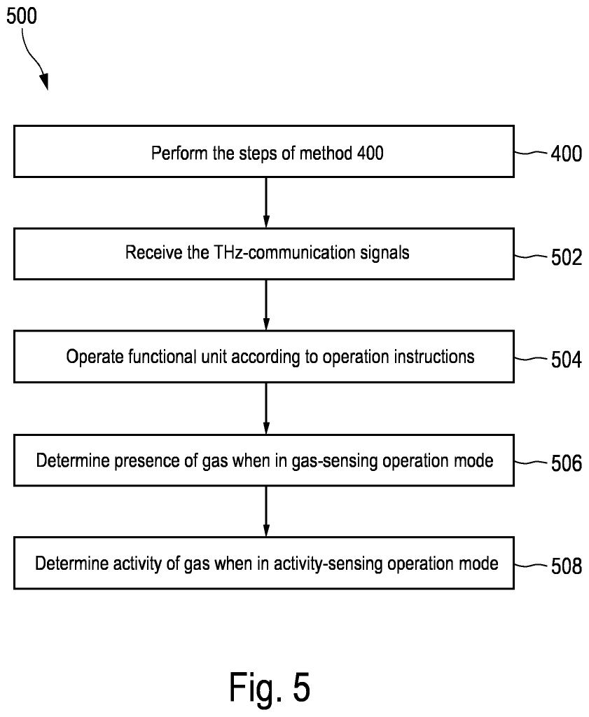

FIG. 5 shows a flow diagram of an embodiment of a method 500 according to the invention for controlling operation of a wireless communication arrangement that comprises at least one wireless transmitter device and a wireless receiver device in wireless data communication with the wireless transmitter device. The method comprises performing the steps of the method 400 of FIG. 4. Additionally, the method comprises, in a step 502, receiving the mm-wave/THz-communication signals. The method also comprises, in a step 504, operating a functional unit of the wireless receiver device in accordance with operation instructions transmitted by the wireless transmitter device via the mm-wave/THz-communication signals. The method also comprises, in a step 506, when the operation data is indicative of the gas-sensing operation mode, determining spectral data indicative of a spectral content of the mm-wave/THz-communication signals and determining the presence of predetermined gases in a gas-sensing volume based thereon; and optionally, in a step 508, when the operation data is indicative of the activity-sensing operation mode, determining signal quality data of the mm-wave/THz-communication signals, the signal quality data indicative of a received signal strength or a channel state of a communication link between the transmitter device and the receiver device, and determining a current activity of one or more subjects within an activity sensing volume using the signal quality data.

In summary, the invention is directed to a wireless transmitter device, comprising a signal provision unit for providing mm-wave/THz-communication signals, an operation-mode ascertaining unit for ascertaining operation data indicative of a desired operation mode from a plurality of available operation modes including a communication operation mode for data communication and a gas-sensing operation mode for sensing, using the mm-wave/THz-communication signals, a presence of a predetermined gas within a gas-sensing volume, and a signal-parameter determination unit connected to the operation-mode ascertaining unit and to the signal provision unit and for determining emission parameters of the mm-wave/THz-communication signals to be provided in dependence on the desired operation mode. The signal provision unit is configured to provide mm-wave/THz-communication signals in accordance with the determined emission parameters and thus enables an increase of the functionality of wireless transmitter devices operating in the mm-wave/THz communication band.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

1. A wireless transmitter device, comprising:
a signal provision unit configured to provide wireless communication signals in the mm-wave communication band or in the THz-communication band or in both the mm-wave communication band and the THz-communication band, hereinafter referred to as mm-wave/THz-communication signals, to one or more wireless receiver devices for data communication in accordance with a predetermined wireless communication protocol;
an operation-mode ascertaining unit configured to ascertain operation data indicative of at least one desired operation mode from a plurality of available operation modes of the wireless transmitter device, wherein the available operation modes include at least a communication operation mode for data communication between the wireless transmitter device and the one or more wireless receiver devices and a gas-sensing operation mode for sensing, using the mm-wave/THz-communication signals, a presence of a predetermined gas within a gas-sensing volume; and
a signal-parameter determination unit connected to the operation-mode ascertaining unit and to the signal provision unit and configured to determine emission parameters of the mm-wave/THz-communication signals to be provided in dependence on the at least one desired operation mode; and wherein
the signal provision unit is further configured to provide mm-wave/THz-communication signals in accordance with the determined emission parameters,
wherein further comprising an environment-data ascertaining unit, connected to the signal-parameter determination unit and configured to ascertain environment-data indicative of a location of the wireless transmitter device and of the one or more wireless receiver devices and/or indicative of elements in the surroundings of the wireless transmitter device and/or the wireless receiver device, which affect the provided mm-wave/THz-communication signals in a detectable manner; wherein
the signal-parameter determination unit is further configured to determine, using the ascertained environment-data, a respective set of emission parameters associated to each available operation modes; and wherein
the signal provision unit is configured to provide the mm-wave/THz-communication signals using the set of emission parameters associated to the desired operation mode, and
wherein, for ascertaining the environment-data, the environment-data ascertaining unit is configured to receive the environment data via a data input;
wherein the data input comprises at least one of a 3D model of the environment, an image data of the environment, LIDAR data, a radiofrequency data, another data type used for identifying a location of the wireless transmitter device and of the one or more wireless receiver devices and/or indicative of elements in the surroundings of the wireless transmitter device and/or the wireless receiver device.

2. The wireless transmitter device of claim 1, wherein the controllable emission parameters include one or more of a transmission frequency of the mm-wave/THz-communication signal, a transmission direction of the mm-wave/THz-communication signal, a beam-form of the mm-wave/THz-communication signal, a polarization of the mm-wave/THz-communication signal, a power amount of the mm-wave/THz-communication signal or any combination thereof.

3. The wireless transmitter device of claim 1, wherein, for ascertaining the environment-data, the environment-data ascertaining unit is configured:
to control provision of mm-wave/THz-communication signals with varying emission parameters,
to receive, from the one or more wireless receiver devices signal-reception data, indicative of the received mm-wave/THz-communication signal; and
to determine the environment-data based on the respective emission parameter and the resulting signal-reception data.

4. The wireless transmitter devices of claim 1, wherein the environment-data ascertaining unit is further configured to ascertain environment-data indicative of presence of people and/or animals within a predetermined volume.

5. The wireless transmitter device of claim 1, wherein the available operation modes further include an activity-sensing operation mode for sensing, using the mm-wave/THz-communication signals, presence and/or motion and/or vital signs of one or more person and/or animal within a sensing volume.

6. The wireless transmitter device of claim 1, wherein the available operation modes further include a wireless-charging mode for wirelessly charging an external device using the mm-wave/THz-communication signals.

7. The wireless transmitter device according to claim 5, further comprising a receiving unit for receiving mm-wave/THz-communication signals, the wireless transmitter device further comprising:
a gas sensing unit connected to the receiver unit and configured to, when the operation data is indicative of the gas-sensing operation mode, determine spectral data indicative of a spectral content of the received mm-wave/THz-communication signals and to determine the presence of predetermined gases in a gas-sensing volume using the spectral data; and optionally
an activity sensing unit, connected to the receiver unit and configured to, when the operation data is indicative of the activity-sensing operation mode, determine signal quality data of the mm-wave/THz-communication signals, the signal quality data indicative of a received signal strength or a channel state of a communication link between the transmitter device and the receiver device, and to determine a current activity of one or more subjects within an activity sensing volume using the signal quality data.

8. The wireless transmitter device of claim 1, wherein when the ascertained operation data is indicative of a gas-sensing operation mode, the signal-parameter determination unit is configured to determine emission parameters that result in a direct or reduced multipath signal trajectory between the wireless transmitter device and one of the one or more wireless receiver devices.

9. A wireless communication arrangement, comprising at least one wireless transmitter device according to claim 1 and a wireless receiver device in wireless data communication with the wireless transmitter device, the wireless receiver device comprising:
a receiver unit configured to receive the mm-wave/THz-communication signals;
a functional unit connected to the receiver unit and being operable in accordance with operation instructions transmitted by the wireless transmitter device via the mm-wave/THz-communication signals; and
a gas sensing unit connected to the receiver unit and configured to, when the operation data is indicative of the gas-sensing operation mode, determine spectral data indicative of a spectral content of the mm-wave/THz-communication signals and to determine the presence of predetermined gases in a gas-sensing volume using the spectral data; and optionally
an operation-mode ascertaining unit configured to ascertain operation data indicative of at least one desired operation mode from a plurality of available operation modes of the wireless transmitter device.

10. The wireless communication arrangement of claim 9, wherein the wireless receiver further comprises an activity sensing unit, connected to the receiver unit and configured to, when the operation data is indicative of the activity-sensing operation mode, determine signal quality data of the mm-wave/THz-communication signals, the signal quality data indicative of a received signal strength or a channel state of a communication link between the transmitter device and the receiver device, and to determine a current activity of one or more subjects within an activity sensing volume using the signal quality data.

11. Method for controlling operation of a wireless transmitter device, the method comprising:
ascertaining operation data indicative of at least one desired operation mode from a plurality of available operation modes of the wireless transmitter device, wherein the available operation modes include at least a communication operation mode for data communication between the wireless transmitter device and the one or more wireless receiver devices and a gas-sensing operation mode for sensing, using the mm-wave/THz-communication signals, a presence of a predetermined gas within a gas-sensing volume; and
determining emission parameters of the mm-wave/THz-communication signals to be provided in dependence on the at least one desired operation mode; and
providing mm-wave/THz-communication signals to one or more wireless receiver devices for data communication in accordance with a predetermined wireless communication protocol and in accordance with the determined emission parameters,
ascertain environment-data indicative of a location of the wireless transmitter device and of the one or more wireless receiver devices and/or indicative of elements in the surroundings of the wireless transmitter device and/or the one or more wireless receiver device, which affect the provided mm-wave/THz-communication signals in a detectable manner,
determining, using the ascertained environment-data, a respective set of emission parameters associated to each available operation modes;
providing the mm-wave/THz-communication signals using the set of emission parameters associated to the desired operation mode, and
wherein, for ascertaining the environment-data, receiving the environment data via a data input;
wherein the data input comprises at lease one of a 3D model of the environment, an image data of the environment, LIDAR data, a radiofrequency data, another data type used for identifying a location of the wireless transmitter device and of the one or more wireless receiver devices and/or indicative of elements in the surroundings of the wireless transmitter devices and/or the wireless receiver device.

12. Method for controlling operation of a wireless communication arrangement, comprising at least one wireless transmitter device and a wireless receiver device in wireless data communication with the wireless transmitter device, the method comprising
performing the steps of the method of claim 11;
receiving the mm-wave/THz-communication signals
operating a functional unit of the wireless receiver device in accordance with operation instructions transmitted by the wireless transmitter device via the mm-wave/THz-communication signals;
when the operation data is indicative of the gas-sensing operation mode, determining spectral data indicative of a spectral content of the mm-wave/THz-communication signals and determining the presence of predetermined gases in a gas-sensing volume based thereon; and optionally
when the operation data is indicative of the activity-sensing operation mode, determining signal quality data of the mm-wave/THz-communication signals, the signal quality data indicative of a received signal strength or a channel state of a communication link between the transmitter device and the receiver device, and determining a current activity of one or more subjects within an activity sensing volume using the signal quality data.

13. Computer program product comprising instructions, which, when the program is executed by a computer, cause the computer to carry out the method of, claim 11.
